(19) United States
(12) Patent Application Publication
(10) Pub. No.: US 2005/0063776 A1
(43) Pub. Date: Mar. 24, 2005

(54) Fastening device for fastening an electrical module on a housing wall

(75) Inventors: Chia-Chi Chang, Hsin-Tien City (TW); Li-Sheui Kuo, Hsin-Tien City (TW); Ed Chang, Hsin-Tien City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Perfect-Three Manufacturing Corp.

(21) Appl. No.: 10/751,849

(22) Filed: Jan. 5, 2004

(30) Foreign Application Priority Data
Sep. 18, 2003 (TW) 092216771

(51) Int. Cl. F16D 1/00

(52) U.S. Cl. 403/408.1

(57) ABSTRACT

A fastening device, which serves for fastening an electrical module on a housing wall that is formed with fastener slots, includes a bracket member and fastening members. Each of the fastening members has a first portion that is secured to the bracket member, a second portion that is opposite to the first portion and that has a size sufficient for passage through one of the fastener slots, and an intermediate portion that interconnects the first and second portions, that cooperates with the bracket member and the second portion to form a groove, and that has a size sufficient for extension through one of the fastener slots. The bracket member is fastened on the housing wall such that a slot periphery of each of the fastener slots is engaged within a respective one of the grooves and such that the each second portion engages the outer surface of the housing wall.

### CROSS-REFERENCE TO RELATED APPLICATION

This application claims priority of Taiwanese application no. 092216771, filed on Sep. 18, 2003.

### BACKGROUND OF THE INVENTION

1. Field of the Invention

The invention relates to a fastening device, more particularly to a fastening device for fastening an electrical module on a housing wall.

2. Description of the Related Art

Referring to FIGS. 1 and 2, a conventional fastening device 1 is shown to include a bracket member 31 and a plurality of fastening members 32. The fastening device 1 is adapted to fasten an electrical module 2 on a housing wall 11, such as that of a cable hub, e.g., a network hub or CATV splitter. The housing wall 11 has inner and outer surfaces, and is formed with a plurality of first fastener holes 15, each of which extends through the inner and outer surfaces of the housing wall 11, and is defined by a hole periphery. The bracket member 31 is mounted with the electrical module 2, such as with the use of screws, has first and second surfaces, and is formed with a plurality of second fastener holes 311, each of which extends through the first and second surfaces of the bracket member 31, and is defined by a hole periphery. Each of the fastening members 32 includes an insert post 322 and an expandible sleeve 321 that are made from plastics. The sleeve 321 has a first portion 3210, a second portion 3212 opposite to the first portion 3210, and an intermediate portion 3214 disposed between the first and second portions 3210, 3212.

To fasten the bracket member 31 on the housing wall 11, the bracket member 31 is disposed on the housing wall 11 such that the second surface of the bracket member 31 abuts against the inner surface of the housing wall 11, and such that each of the second fastener holes 311 in the bracket member 31 is aligned with a respective one of the first fastener holes 15 in the housing wall 11. The sleeve 321 of each of the fastener members 32 is then inserted to extend through a respective aligned pair of the first and second fastener holes 15, 311 such that the first portion 3210 of the sleeve 321 is disposed adjacent to the outer surface of the housing wall 11, such that the intermediate portion 3214 of the sleeve 321 is disposed in the respective aligned pair of the first and second fastener holes 15, 311, and such that the second portion 3212 of the sleeve 321 engages the bracket member 31 at the hole periphery of the respective one of the second fastener holes 311. The insert post 322 is subsequently inserted into the sleeve 321, whereby the first portion 3210 of the sleeve 321 expands radially and engages the housing wall 11 at the hole periphery of the respective one of the first fastener holes 15, thereby fastening the bracket member 31 on the housing wall 11. To unfasten the bracket member 31, the bolt 322 is pulled out from the respective sleeve 321, and each sleeve 321 is subsequently pulled out from the respective aligned pair of the first and second fastener holes 15, 311.

Although the conventional fastening device 1 achieves the purpose of fastening the bracket member 31 on the housing wall 11, the fastening and unfastening operations of the bracket member 31 on the housing wall 11 are relatively difficult to perform. Furthermore, since the fastening members 32 are required to be made from plastics, the fastening members 32 are easily deformed or damaged due to heat generated by the electrical module 2.

### SUMMARY OF THE INVENTION

Therefore, the object of the present invention is to provide a fastening device that facilitates fastening and unfastening of an electrical module on and from a housing wall.

According to the present invention, a fastening device comprises a bracket member and a plurality of fastening member. The fastening device is adapted to fasten an electrical module on an upright housing wall. The housing wall has inner and outer surfaces opposite to each other in a first direction, and is formed with a plurality of fastener slots, each of which extends through the inner and outer surfaces of the housing wall and is defined by a slot periphery. The bracket member is adapted to be mounted with the electrical module and is to be disposed on the inner surface of the housing wall. Each of the fastening members has a first portion that is secured to the bracket member, a second portion that is spaced apart from the first portion in the first direction and that has a size sufficient for passage through one of the fastener slots, and an intermediate portion that extends in the first direction, that interconnects the first and second portions, that cooperates with the bracket member and the second portion to form a wall engaging groove, and that has a size sufficient for extension through one of the fastener slots. Each of the fastening members is adapted to be extended through a respective one of the fastener slots when the bracket member is brought in the first direction toward the inner surface of the housing wall such that the second portion is disposed adjacent to the outer surface of the housing wall, and such that the intermediate portion is disposed in the respective one of the fastener slots. The bracket member is movable in a second direction transverse to the first direction by virtue of gravity such that the slot periphery of each of the fastener slots is engaged within a respective one of the wall engaging grooves and such that the second portions of the fastening members are adapted to engage the outer surface of the housing wall.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional fastening device;

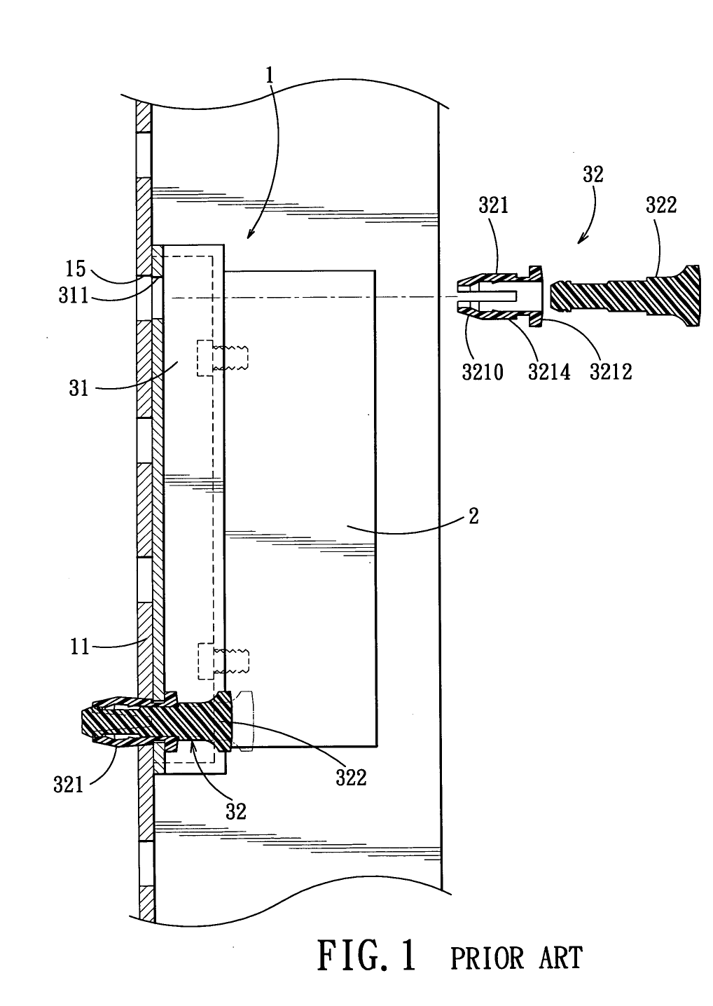

FIG. 2 is a schematic view of the conventional fastening device in a state of use to fasten an electrical module on a housing wall;

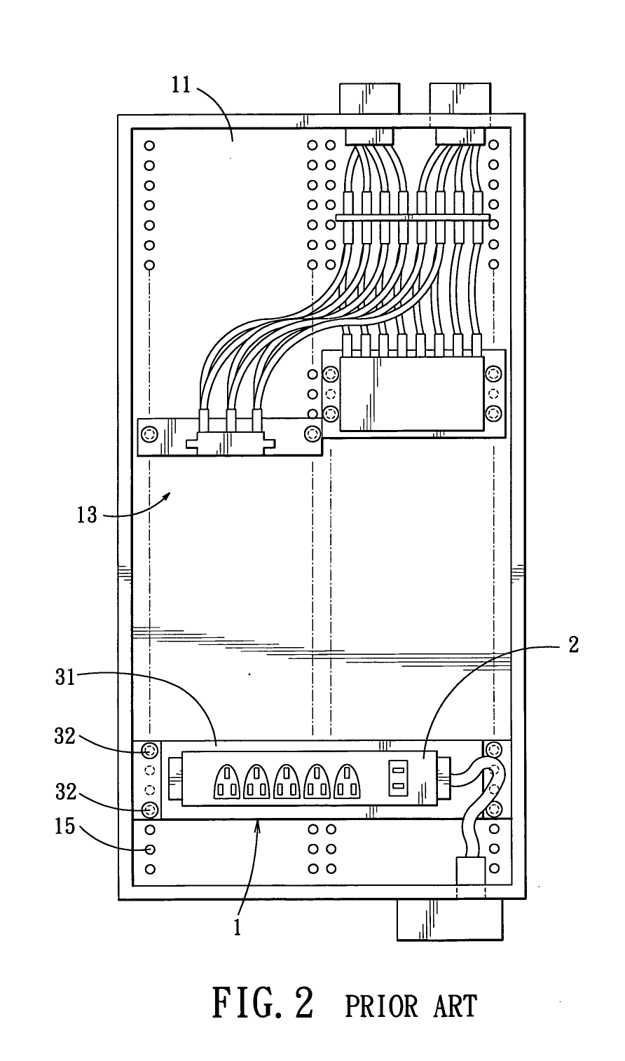

FIG. 3 is a sectional view of the preferred embodiment of a fastening device according to the present invention;

FIG. 4 is a schematic view of the preferred embodiment is a state of use to fasten an electrical module on a housing wall; and

FIG. 5 is a sectional view of FIG. 4.

### DETAILED DESCRIPTION OF THE PREFERRED EMBODIMENT

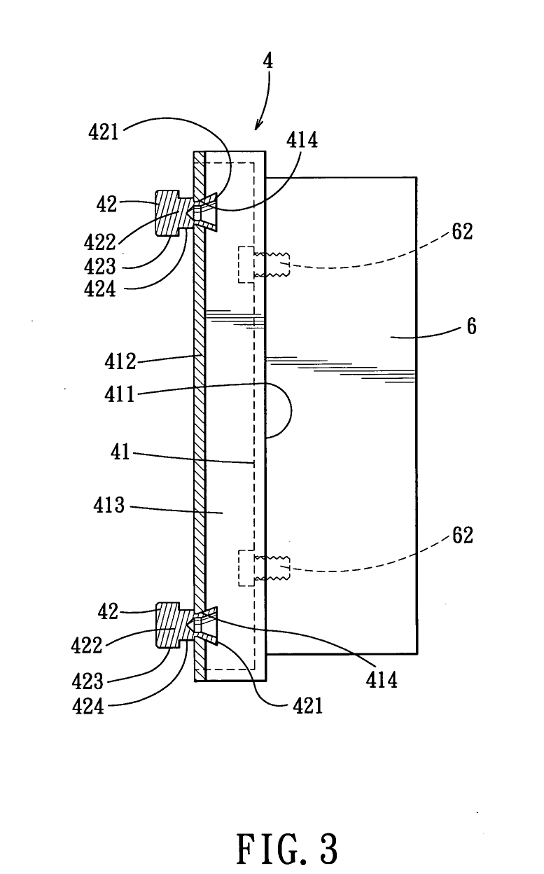

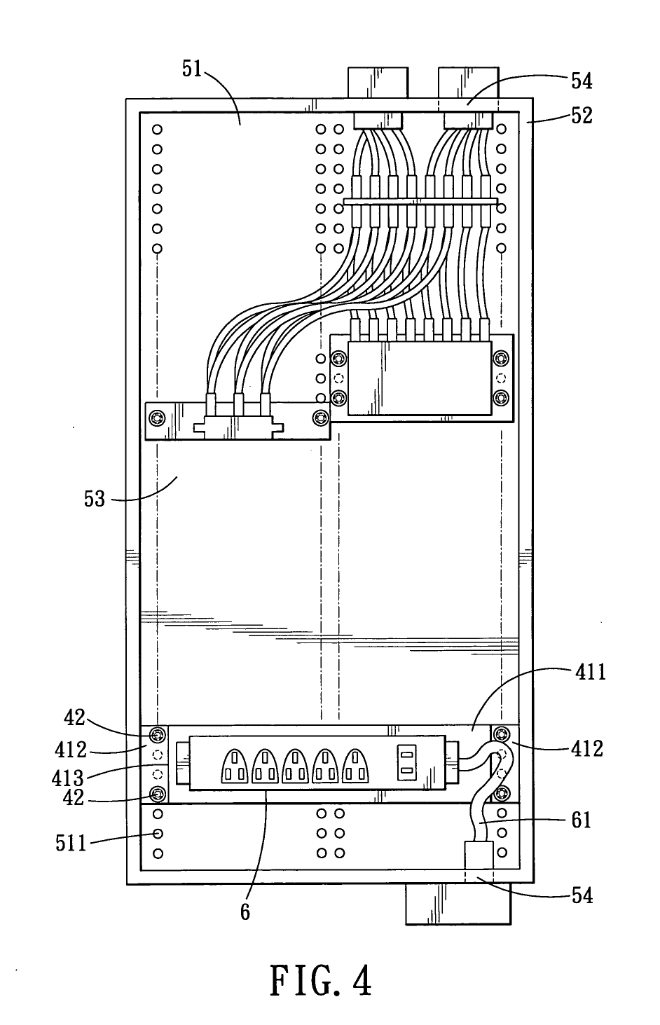

Referring to FIGS. 3 to 5, the preferred embodiment of a fastening device 4 according to this invention is shown to include a bracket member 41 and a plurality of fastening members 42.

The fastening device 4 is adapted to fasten an electrical module 6 on an upright housing wall 51, such as that of a cable hub, e.g., a network hub or CATV splitter. The housing wall 51 includes base and surrounding portions 53, 52. The base portion 53 of the housing wall 51 has inner and outer surfaces that are opposite to each other in a first direction. The surrounding portion 52 extends from a periphery of the base portion 53 and surrounds the inner surface of the base portion 53. In this embodiment, the base portion 53 of the housing wall 51 is formed with a plurality of fastener slots 511, each of which extends through the inner and outer surfaces of the base portion 53 of the housing wall 51, and is defined by a slot periphery. Furthermore, the surrounding portion 52 of the housing wall 51 is formed with a plurality of cable holes 54, each of which extends through inner and outer surfaces of the surrounding portion 52. The electrical module 6 includes a cable 61 that is passed through one of the cable holes 54.

The bracket member 41 is adapted to be mounted with the electrical module 6, is to be disposed on the inner surface of the base portion 53 of the housing wall 51, and is formed with a plurality of through holes 414, each of which is defined by a hole periphery. In particular, the bracket member 41 has a mounting portion 411, a pair of connecting portions 413, and a pair of positioning portions 412. Each of the connecting portions 413 extends from a respective end of the mounting portion 411 toward the inner surface of the base portion 53 of the housing wall 51. Each of the positioning portions 412 is spaced apart from the mounting portion 41 and extends from a respective one of the connecting portions 413 so as to be disposed on a respective one of left and right end parts of the base portion 53 of the housing wall 51. The electrical module 6 is mounted on the mounting portion 411 with the use of screws 62. It is noted herein that the electrical module 6 can be mounted on the mounting portion 411 using any other suitable means. The through holes 414 are formed in each of the positioning portions 412.

Each of the fastening members 42 is preferably a rivet 422 made from stainless steel. As such, the fastening members 42 are not susceptible to deformation or damage due to heat generated by the electrical module 6. In this embodiment, each of the fastening members 42 has first, intermediate and second portions 421, 424, 423. The first portion 421 is secured to the bracket member 41. In particular, the first portion 421 of each of the fastening members 42 is tubular, extends through a respective one of the through holes 414 in the positioning portions 412 of the bracket member 41, and is flared so as to engage the bracket member 41 at the hole periphery of the respective one of the through holes 414. It is noted that the first portion 421 of each of the fastening members 42 is deformed by hammering after being passed through the respective through hole 414. The second portion 423 is spaced apart from the first portion 421 in the first direction, and has a size sufficient for passage through one of the fastener slots 511. The intermediate portion 424 extends in the first direction, interconnects the first and second portions 421, 423, cooperates with one of the positioning portions 412 of the bracket member 41 and the second portion 423 to form a wall engaging groove, and has a size sufficient for extension through one of the fastener slots 511.

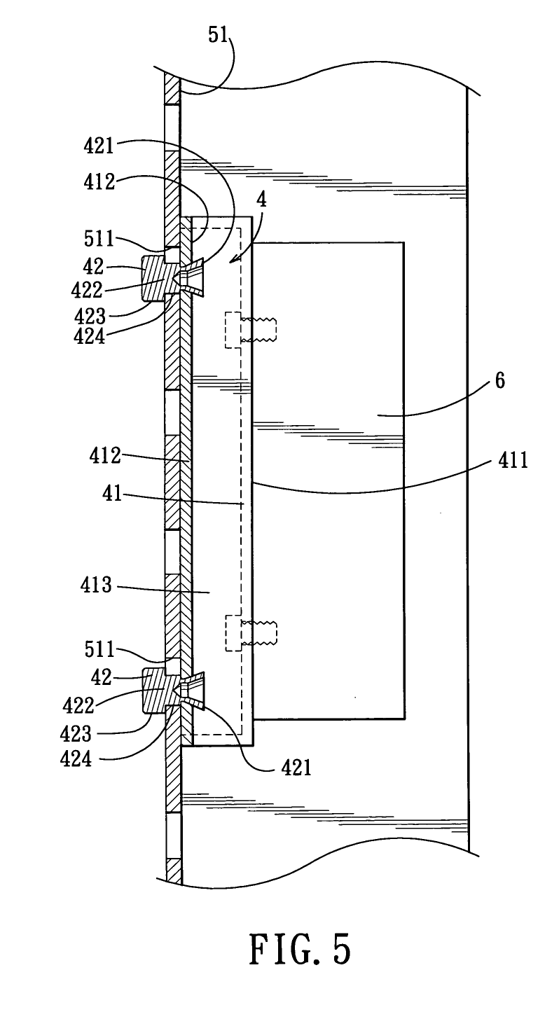

From the above description, as best shown in FIG. 5, each of the fastening members 42 is adapted to be extended through a respective one of the fastener slots 511 when the bracket member 41 is brought in the first direction toward the inner surface of the base portion 53 of the upright housing wall 51 such that the second portion 423 is disposed adjacent to the outer surface of the base portion 53, and such that the intermediate portion 424 is disposed in the respective one of the fastener slots 511. The bracket member 41 is subsequently movable in a second direction transverse to the first direction by virtue of gravity such that the slot periphery of each of the fastener slots 511 is engaged within a respective one of the wall engaging grooves and such that the second portions 423 of the fastening members 42 are adapted to engage the outer surface of the base portion 53 of the upright housing wall 51, thereby fastening the bracket member 41 on the base portion 53 of the housing wall 51. The bracket member 41 can be unfastened from the base portion 53 of the housing wall 51 by performing the aforementioned steps in a reverse order.

It has thus been shown that the fastening device 4 of this invention includes a bracket member 41 and a plurality of fastening members 42. Each of the fastening members 42 has a first portion 421 secured to the bracket member 41, a second portion 423, and an intermediate portion 424 that cooperates with the bracket member 41 and the second portion 423 to form a wall-engaging groove. The construction as such permits the bracket member 41 to be fastened on and unfastened from the housing wall 51 with relative ease.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A fastening device adapted to fasten an electrical module on an upright housing wall, the housing wall having inner and outer surfaces opposite to each other in a first direction, and being formed with a plurality of fastener slots, each of which extends through the inner and outer surfaces of the housing wall and is defined by a slot periphery, said fastening device comprising:
a bracket member adapted to be mounted with the electrical module and to be disposed on the inner surface of the housing wall; and
a plurality of fastening members, each of which has a first portion that is secured to said bracket member, a second portion that is spaced apart from said first portion in the first direction, and an intermediate portion that extends in the first direction, that interconnects said first and second portions, and that cooperates with said bracket member and said second portion to form a wall engaging groove, said second portion having a size sufficient for passage through one of the fastener slots, said intermediate portion having a size sufficient for extension through one of the fastener slots,
each of said fastening members being adapted to be extended through a respective one of the fastener slots when said bracket member is brought in the first direction toward the inner surface of the housing wall such that said second portion is disposed adjacent to the outer surface of the housing wall, and such that said intermediate portion is disposed in the respective one of the fastener slots,
said bracket member being movable in a second direction transverse to the first direction by virtue of gravity such that the slot periphery of each of the fastener slots is engaged within a respective one of said wall engaging grooves and such that said second portions of said fastening members are adapted to engage the outer surface of the housing wall.

2. The fastening device as claimed in claim 1, wherein said bracket member is formed with a plurality of through holes, said first portion of each of said fastening members being tubular, extending through a respective one of said through holes, and being flared so as to engage said bracket member at a periphery of the respective one of said through holes.
